(19) United States
(12) Patent Application Publication
(10) Pub. No.: US 2008/0105768 A1
(43) Pub. Date: May 8, 2008

(54) Dosing Elements for a Drip Irrigation Tube and Method and Device for Producing these Dosing Elements

(76) Inventor: Eberhard KERTSCHER, Yvonand (CH)

Correspondence Address: DORSEY & WHITNEY LLP, 555 CALIFORNIA STREET, SUITE 1000, SUITE 1000, SAN FRANCISCO, CA, 94104, US

(21) Appl. No.: 11/936,678

(22) Filed: Nov. 7, 2007

(30) Foreign Application Priority Data
Nov. 7, 2006 (EP) 06123612.1

(51) Int. Cl. B05B 15/00; B29C 47/04; D01D 5/24

(52) U.S. Cl. 239/542; 264/209.1; 425/192 R

(57) ABSTRACT

Dosing elements for a drip irrigation tube are produced in the form of a band. On one side of this band, structured elements are formed, disposed one behind the other. The band is connectible by this one side to the walling of a drip irrigation tube. Each structured area here has an inlet region, a dosing region, and an outlet region. The band consists of a support band which is longitudinally stable and flexible, which is provided on one side with a layer, in which layer structured areas are made. Described furthermore is a method for producing these dosing elements as well as a device for carrying out this method.

This invention relates to dosing elements for a drip irrigation tube, which are designed in the form of a band, provided on one side with structured areas disposed behind one another, which band is connectible by this one side to the walling of the tube body forming the drip irrigation tube, and each of the structured areas comprises an inlet region, a dosing region and an outlet region. This invention also relates to a method and a device for producing these dosing elements.

Drip irrigation tubes provided with dosing elements are used for direct irrigation of plants. For this purpose drip irrigation tubes can be designed, for example, in such a way that an outlet region of a dosing element is located in the region of each plant, through which dosing element the water is emitted dropwise from the drip irrigation tube. Each of the individual plants can hereby be irrigated directly, whereby the water usage is very economical. Prevented is that a large quantity of water for irrigation evaporates, as usually happens with irrigation facilities through which the water is distributed over a large area via spray installations. Thus achieved by drip irrigation via these drip irrigation tubes is a very economical irrigation.

Producing drip irrigation tubes with individual dosing elements is known. For this purpose, during the process of extrusion of the tube body for the drip irrigation tube, individual dosing elements are supplied, which are then pressed on the walling of the freshly extruded tube body. Then an opening is made in the walling of the tube body in the region of the outlet of the dosing element. For this purpose it is necessary to know very precisely the position of the outlet region of the dosing element so that the exit hole can be made at the correct place. Such a solution is known, for example, from EP-A 715 926. It has been shown that with this means of manufacture of drip irrigation tubes, the speed of production is limited.

Producing drip irrigation tubes is also known in which, instead of the dosing elements inserted individually in the drip irrigation tubes, these dosing elements are accommodated in an endless band, as is known, for example, from WO 03/066228. Used for this purpose can be a band made of an elastic material, on whose one side structural areas are made which each have a dosing element with an inlet region, a dosing region, and an outlet region. This band is connected to the walling of the tube body forming the drip irrigation tube. Since this band consists of an elastic material, its handling during the manufacture of the drip irrigation tubes is not very easy, also in particular because it must be very thin because of the possibility of influencing the dosing through deformation of the band owing to pressure differences in the water in the drip irrigation tube. This is then particularly disadvantageous when a high rate of production is supposed to be achieved.

The object of this invention thus consists in creating dosing elements for a drip irrigation which have a good stability, in which the providing of the structured areas can take place in a simple way, and with which in particular high production rates are achievable in the manufacture of drip irrigation tubes with dosing elements of this kind.

This object is achieved according to the invention in that the band comprises a substantially longitudinally stable, flexible support band which is provided with a layer on one side, in which layer the structured areas are made.

With this design the objects set may be achieved.

Preferably the support band is made of a mechanically resistant synthetic material, for example of high density polyethylene (HDPE), a polypropylene or a similar suitable material.

In addition, the layer is preferably made of a thermoplastic synthetic material in which the structured areas are able to be formed by stamping in a simple way. Used for this purpose can be, for example, a linear low density polyethylene (LLDPE) or an easily moldable adhesive, e.g. of PA (polyamide) basis.

A further advantageous embodiment of the invention is achieved in that the band is installable inside on the walling of the tube body, in that the inlet region made in the layer consists of protrusions disposed next to one another or behind one another, in that the dosing region is formed by two lateral walls and transverse ribs, connected to the lateral walls and protruding toward the middle, and in that the outlet region consists of a space closed by lateral walls, the walling of the tube body being provided with an opening in this region. Besides the simple manufacture through stamping of the structured areas in the layer of the band, this design results in an optimal mode of operation of the dosing elements.

The transverse ribs are preferably disposed inclined toward the outlet region, and are substantially tapered toward the free end. Thereby achieved is an optimal dosing effect for the water.

Another object of the invention consists in creating a method with which the dosing elements can be produced simply and optimally, which is achieved according to the invention in that a support band is extruded and is deposited and cooled on an endless guide means, a layer is provided on the cooled and solidified support band, the structured areas are stamped in the layer, and the layer is cooled during the stamping of the structured areas.

The extruded support band is cooled on the endless guide means, and the support band with the provided layer and the stamped structured areas is also cooled. Through the cooling of the support band before the layer is provided thereon, this support band acquires the desired mechanical stability, whereby an optimal further processing is made possible. The subsequent cooling of the layer results in the desired and required hardening of the stamped structured areas for the further processing. Through this the structured areas no longer become obliterated.

The thus produced support band with the layer provided thereon and the structured areas stamped therein can be introduced directly into an installation for production of drip irrigation tubes. A simple configuration of the entire production facility thereby results; no interim storage of the dosing elements is necessary.

A further object of the invention consists in creating a device for carrying out the method for producing dosing elements which is simple in construction and with which the dosing elements can be produced at the required speed, which is achieved according to the invention in that disposed in a frame is a first extruding device, with which the support band is able to be extruded and is able to be deposited on the endless guide means, installed on the frame is a second extruding device with which the layer is able to be provided on the support band, and provided on the frame is a stamping device with which the structured areas are stampable into the layer.

The endless guide means is preferably designed as a rotatable wheel, the support band lies on its circumferential surface after the extrusion, and wraps around the wheel partially, and the circumferential surface of the wheel is coolable. A simple structure of the device is thereby achieved.

A further advantageous design of the invention consists in that the stamping device is designed as a rotatable roller on whose circumferential surface a structuring is provided corresponding to a negative form of at least one structured area. This, too, results in a simple structure of the device; a precise stamping is ensured.

Preferably, during the stamping step, the support band provided with the layer is led clamped between the wheel and the roller, the roller is coolable, and the support band provided with the stamped layer wraps around the roller at least partially. This also contributes toward the structured areas being achievable in the layer in an optimal way.

Embodiments of the invention are explained more closely in the following, by way of example, with reference to the attached drawing:

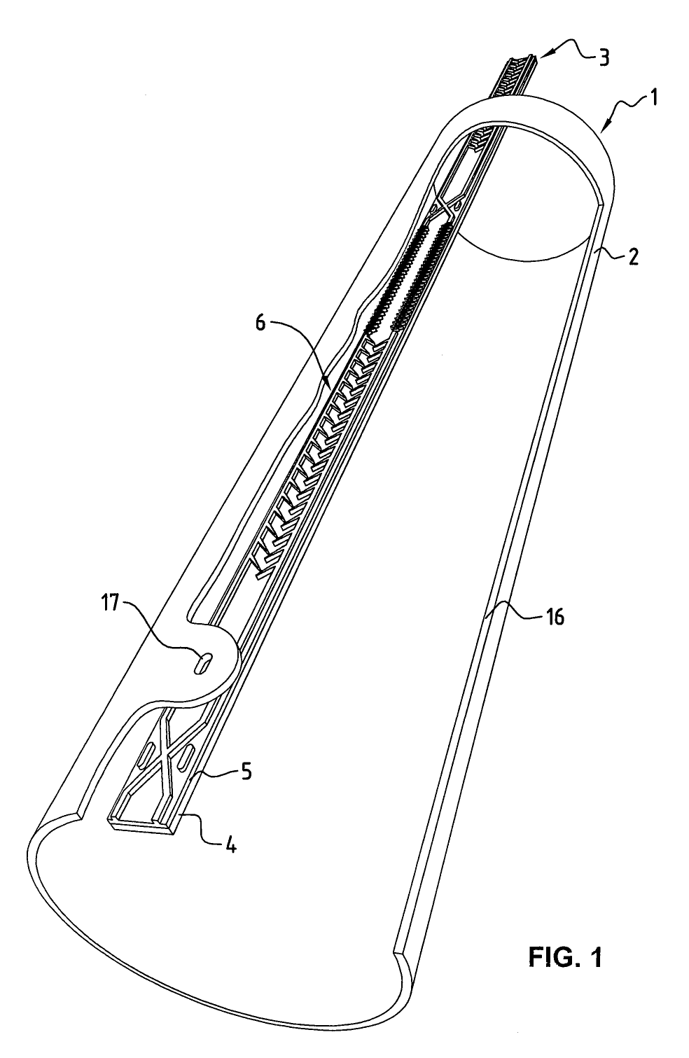

FIG. 1 shows, in a spatial representation, a section of a drip irrigation tube with inserted dosing element, partially in section;

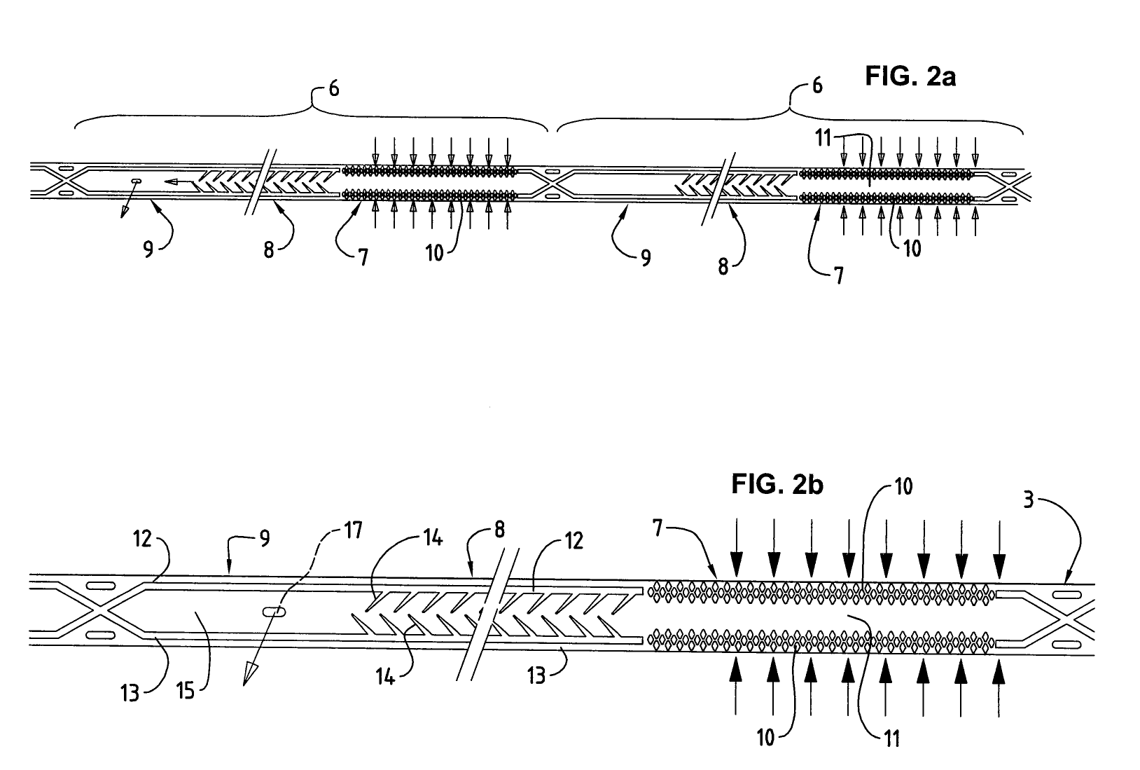

FIG. 2a shows a view of the structured areas stamped in the layer of the band, each structured area forming a dosing element;

FIG. 2b shows an enlarged view of a structured area, which forms a dosing element, according to FIG. 2a;

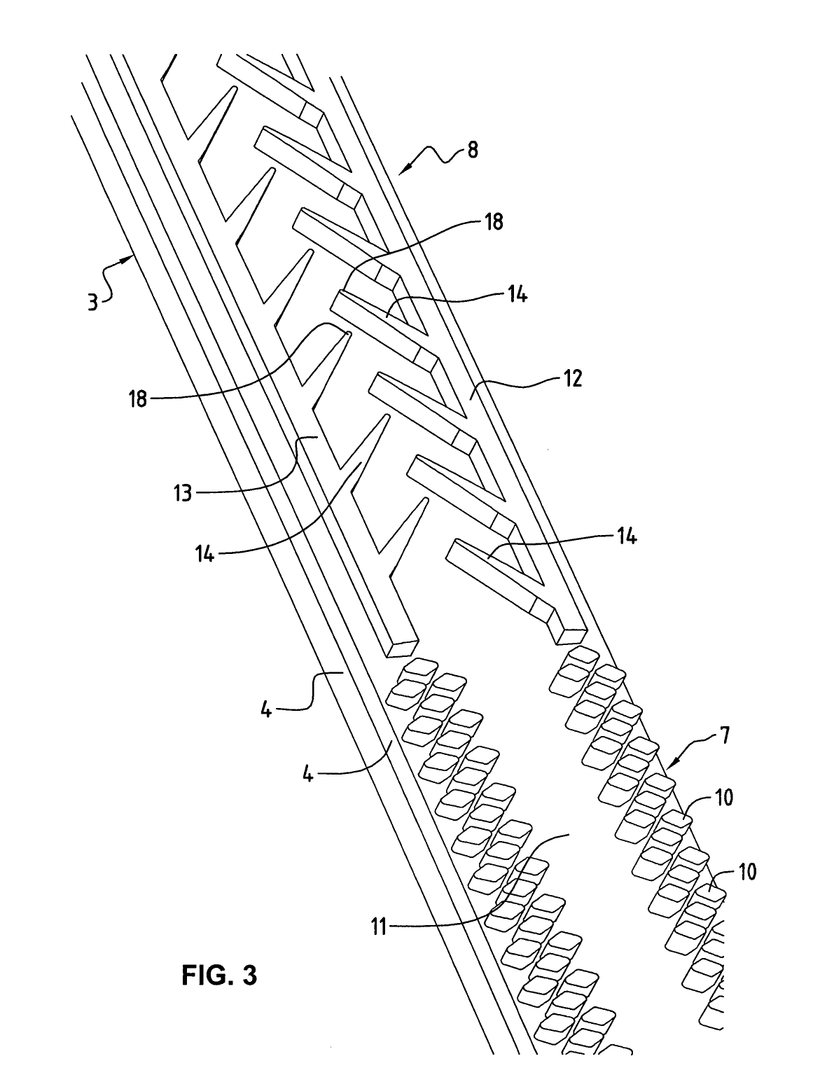

FIG. 3 shows, in a spatial representation, a detail of a structured area;

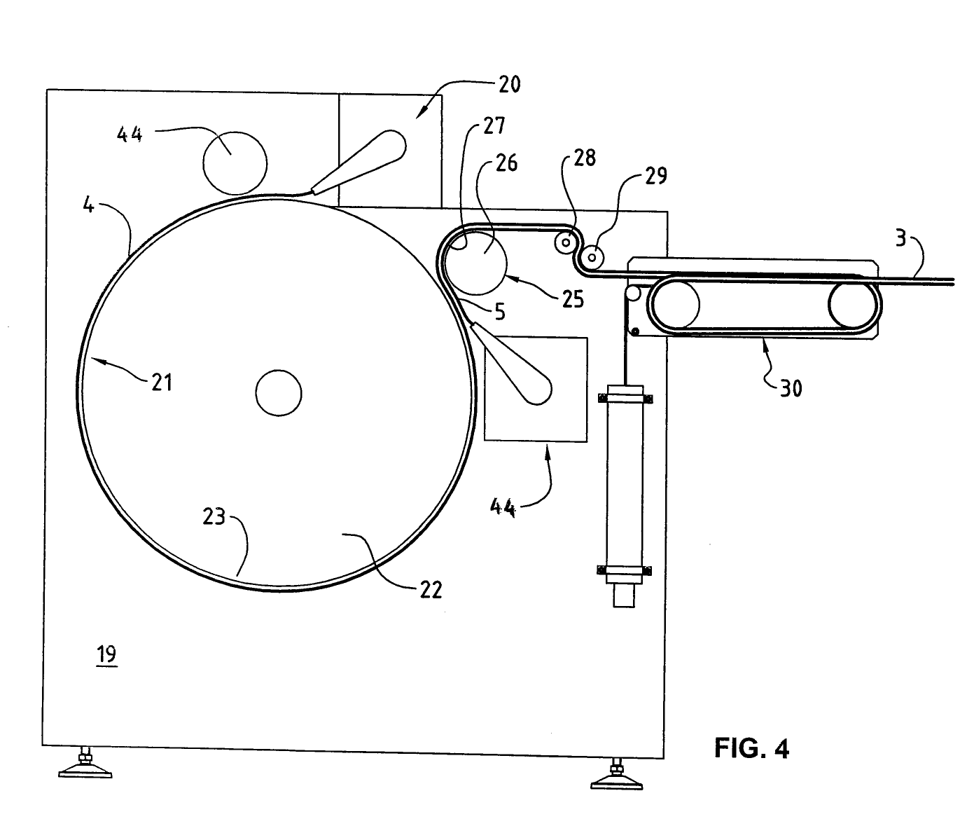

FIG. 4 shows, in a diagrammatic representation, a view of a device for producing the dosing elements;

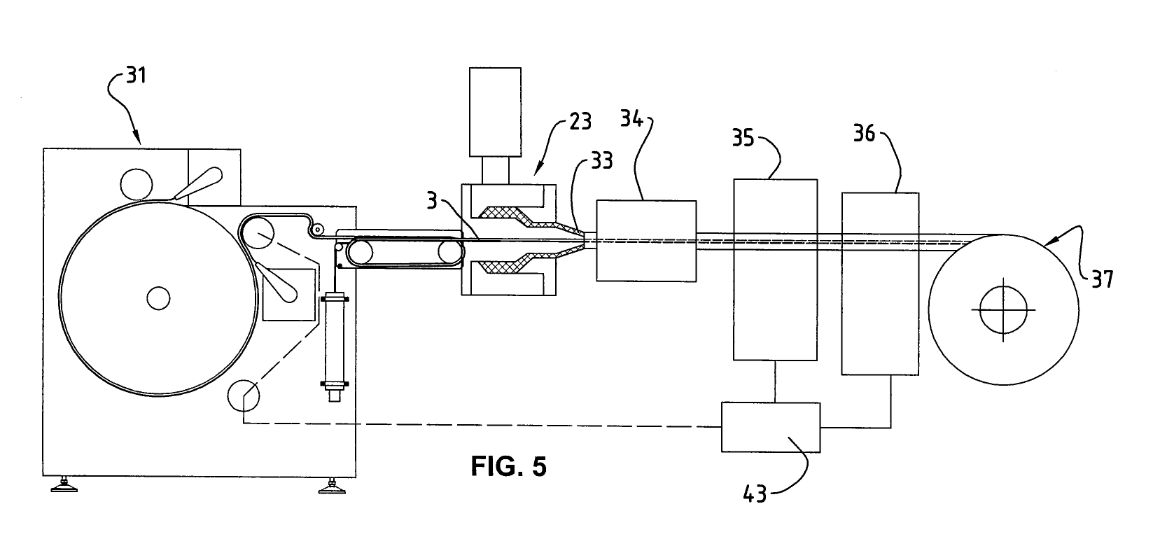

FIG. 5 shows, in a diagrammatic representation, a view of a device for manufacture of drip irrigation tubes provided with dosing elements; and

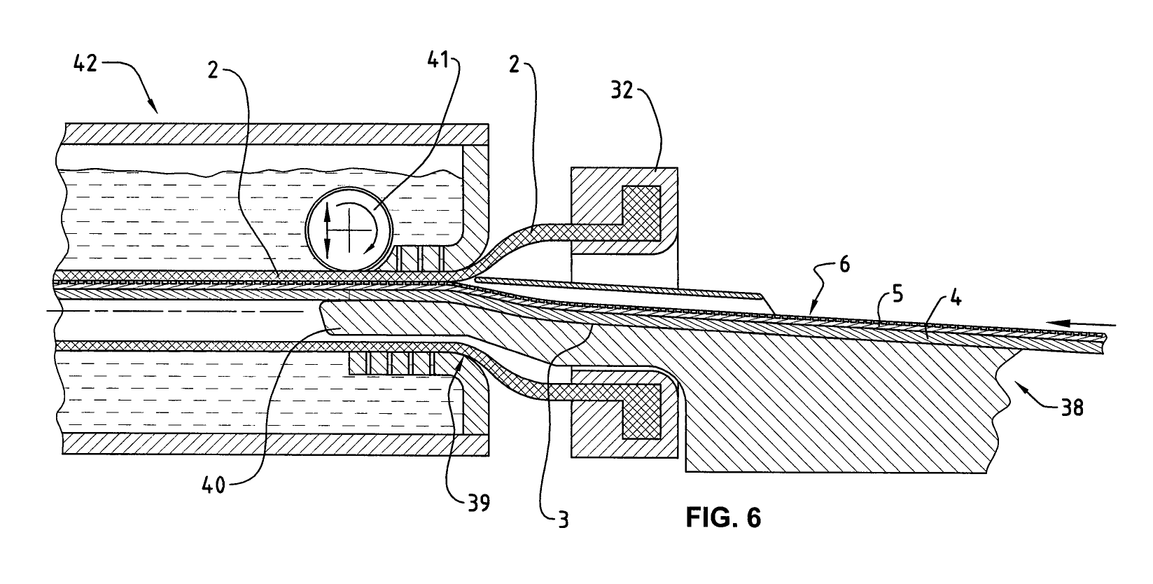

FIG. 6 shows, in section, an enlarged representation of the area of the device, according to FIG. 5, in which the dosing elements are connected to the walling of the drip irrigation tube.

In FIG. 1, a section of a drip irrigation tube 1 is shown three-dimensionally. This drip irrigation tube 1 is formed by a tube body 2, in which a piece has been cut out in FIG. 1, for the sake of clarity. As will still be described later on, this tube body 2 is obtained through an extrusion step. Inserted in this tube body is a band 3, which, as will likewise be seen later, consists of a support band 4, whose one side is provided with a layer 5, in which layer 5 structured areas 6 are made. The band 3 is connected by the surface of these structured areas 6 of the layer 5 to the inner side of the walling 16 of the tube body 2.

As can be seen from FIG. 2a, this band 3 is an endless band. The layer has structured areas 6 disposed one behind the other. As can also be seen from FIG. 2b, each structured area 6 is composed of an inlet region 7, a dosing region 8 and an outlet region 9.

The inlet region 7 is formed by adjacently and consecutively disposed protrusions 10. Between the protrusions 10 there is an interim space through which the water, which is located under high pressure in the tube body 2, can arrive in the inlet chamber 11. Formed at the same time by the protrusions 10 and the interim space is a filter for the water passing through.

From this inlet chamber 11, the water reaches the dosing region 8. This dosing region 8 consists of two lateral walls 12 and 13 which run along the longitudinal edges of the band 3. Connected to the lateral walls 12 and 13 are transverse ribs 14, which project toward the middle. Through the labyrinth, formed by the lateral walls 12 and 13 and the transverse ribs 14, the pressure of the water passing through is reduced.

Other profiles for reaching the desired turbulence are also possible.

After passing through the dosing region 8, the water reaches the outlet region 9. This outlet region 9 consists of an outlet chamber 15, which is formed by the two lateral walls 12 and 13 delimiting the dosing chamber 8 and continuing on, which are led together at the end remote from the dosing region and which close off the outlet chamber 15. From this outlet chamber 15 the water is emitted dropwise through an exit hole 17 (FIG. 1) made in the walling 16 of the tube body 2 into the soil to be irrigated.

Shown in FIG. 3 in an enlarged representation is a portion of the inlet region 7 and a portion of the dosing region 8 of the band 3. Visible in the inlet region 7 are the protrusions 10. The water can reach the inlet chamber 11 through the interim space existing between the protrusions 10. Visible in the dosing region 8 are the two lateral walls 12 and 13, on which the transverse ribs 14 are formed. These transverse ribs 14 are inclined toward the outlet region 9 (FIG. 2b), and are substantially tapered toward the free end 18. An optimal turbulence of the water passing through is thereby achieved, whereby the desired reduction of the pressure of the water is obtained.

The band 3 has a width of about 5 to 8 mm. The thickness of the support band 4 amounts to some tenths of a millimeter. The height of the structures made in the layer 5 likewise amounts to some tenths of a millimeter. The surfaces of the structured elements (protrusions 10, lateral walls 12, 13, transverse ribs 14) are located in the same plane. With these surfaces the band 3 is connected to the inner side of the walling of the tube body, whereby the respective chambers are formed which are passed through by the water.

FIG. 4 shows diagrammatically a device with which the dosing elements can be produced in the form of a band 3. This device comprises a frame 19, on which a first extruding device 20 is disposed. With this first extruding device 20, the support band 4 can be extruded, which support band 4 is deposited on an endless guide means 21, which is designed in this embodiment example as a rotatable wheel 22, which is driven. The extruded support band 4 is deposited on the circumferential surface 23 of this wheel 22. Via a form roller 24, the extruded material is brought into support band shape. This support band 4 then wraps around the wheel 22, around a portion of its circumference, is cooled in this phase since the circumferential surface 23 of the wheel 22 can be cooled in a known way, and thereby acquires the necessary mechanical stability, in particular tensile strength. In order to achieve this, a high density polyethylene (HDPE) can be used as the material for the support band 4. Of course other suitable materials are also conceivable.

The support band 4 lying on the circumferential surface 23 of the wheel 22 reaches a second extruding device 44, which is likewise disposed on the frame 19. The layer 5 is extruded on the support band 4 with this second extruding device 44. The thus coated support band 4 is then led between the wheel 22 and a stamping device 25, which is designed in this embodiment example as a rotatable roller 26, which is likewise driven, and is synchronized with the entire facility. On the circumferential surface 27, this roller 26 is provided with a structuring corresponding to a negative shape of a structured area 6 (FIG. 2a), for example, or a whole number multiple thereof. The structured areas are thereby impressed into the still well moldable material of which the layer 5 consists. Here the material can be a linear low density polyethylene (LLDPE). Of course it can also be any suitable material that can be well formed and impressed.

The support band 4 with the layer 5 applied thereon wraps around the roller 26 partially, and is then led via guide rollers 28, 29 into a known length adjustment device 30, from where the band is then led away. During the wrapping around the roller 26, the structured layer 5 is cooled since the roller 26 is also coolable in a known way. Through the cooling, the layer 5 and the structures impressed therein obtain the desired dimensional stability and solidity, which is necessary for the further processing; an “obliteration” of the structures stamped in the layer 5 is thereby avoided.

The cooling of the wheel 22 and of the roller 26 can take place in a known way (not shown) through water which is led through cooling channels made in the wheel 22 or respectively in the roller.

As can be seen from FIG. 5, this device 31 can be brought into line with an installation for manufacture of drip irrigation tubes. The band 3 produced with this device 31, which band is turned by 180° in a known way in the embodiment example shown here, arrives in an extrusion installation 32, where the tube body is produced. The tube body 33 with the inserted band 3 passes through a calibration and cooling device 34, in which the band 3 is connected to the tube body 33, as will still be seen in the following. Afterwards the tube is led through a device 35, in which the exit hole 17 (FIG. 1) is made in the tube walling, which can take place, for instance, by means of a rotating blade. Of course the making of this exit hole can also be achieved through a laser bore device or any other suitable device. Via a feed device 36, the tube thus produced can be wound on a winding device 37. The thus fabricated drip irrigation tube can then be delivered as a wound roll.

Of course this device for production of drip irrigation tubes is provided in a known way with a control device 43, shown schematically, with which, for example, the speeds of the wheel 22, of the roller 26, of the bore device 35, of the feed device 36 and of the extruded body are synchronized.

As can be seen from FIG. 6, the band 3, which comprises the support band 4 and the layer 5 applied thereon with the structured areas 6 stamped therein, is led into the extruding device 32 with which the tube body 2 is extruded. The band 3 arrives on a feed device 38 in the calibration region 39, where it comes into contact with the tube body 2. The band 3 and the tube body 2 are passed through between a pressing element 40, on which the band 3 lies, and a pressing roller 41; the band 3 with the structured surface is pressed together and connected, or respectively welded, together with the walling of the tube body 2 which is still in a soft state in this region from the extrusion process. Afterwards the thus manufactured drip irrigation tube passes in a known way through the cooling device 42; the tube body and the connection to the band is hardened.

With this invention, drip irrigation tubes can be produced in a simple way and in particular at high speed. These drip irrigation tubes can hereby have different wall thicknesses, depending upon whether these drip irrigation tubes are used only for one season or for several years.

1. Dosing elements for a drip irrigation tube, which are designed in the form of a band with structured areas disposed behind one another on one side, which band is connectible by this one side to the walling of the tube body forming the drip irrigation tube, and each of the structured areas comprises an inlet region, a dosing region and an outlet region, wherein the band comprises a substantially longitudinally stable, flexible support band which is provided on one side with a layer in which layer the structured areas are provided.

2. Dosing elements according to claim 1, wherein the support band is made of a mechanically resistant plastic.

3. The dosing element according to claim 1, wherein the layer is made of a thermoplastic synthetic material.

4. The dosing element according to claim 1, wherein the band is installable inside on the walling of the tube body, the inlet region made in the layer consists of protuberances disposed adjacent one another and/or behind one another, the dosing region is formed by two lateral walls and transverse ribs, connected to the lateral walls and projecting toward the middle, and the outlet region consists of a space closed by lateral walls.

5. The dosing element according to claim 4, wherein the transverse ribs are disposed inclined toward the outlet region and are substantially tapered toward the free end.

6. A method of producing dosing elements for a drip irrigation tube, which are designed in the form of a band with structured areas disposed behind one another on one side, which band is connectible by this one side to the walling of the tube body forming the drip irrigation tube, and each of the structured areas comprises an inlet region, a dosing region and an outlet region, wherein a support band is extruded and is deposited and cooled on an endless guide means, a layer is provided on the cooled and solidified support band, the structured areas are stamped in the layer, and the layer is cooled during the stamping of the structured areas.

7. The method according to claim 6, wherein the support band with the layer applied thereon and the structured areas stamped therein is introduced into an installation for producing drip irrigation tubes.

8. A device for producing dosing elements for a drip irrigation tube, which are designed in the form of a band with structured areas disposed behind one another on one side, which band is connectible by this one side to the walling of the tube body forming the drip irrigation tube, and each of the structured areas comprises an inlet region, a dosing region and an outlet region, wherein disposed in a frame is a first extruding device, with which the support band is able to be extruded and is able to be deposited on the endless guide means, installed on the frame is a second extruding device with which the layer is able to be provided on the support band, and provided on the frame is a stamping device with which the structured areas are stampable into the layer.

9. The device according to claim 8, wherein the endless guide means is designed as a rotatable wheel, the support band lies on its circumferential surface, and wraps around the wheel partially, and the circumferential surface of the wheel is coolable.

10. The device according to claim 8, wherein the stamping device is designed as a rotatable roller on whose circumferential surface a structuring is provided corresponding to a negative form of at least one structured area.

11. The device according to claims 9 and 10, wherein during the stamping process the support band provided with the layer is guided clamped between the wheel and the roller, the roller is coolable, and the support band provided with the stamped layer wraps around the roller at least partially.
